(19) United States
(12) Patent Application Publication
(10) Pub. No.: US 2021/0076694 A1
(43) Pub. Date: Mar. 18, 2021

(54) DRINKABLE DAIRY PRODUCT WITH MULTIPLE GAS EFFECT AND METHOD OF MAKING SAME

(71) Applicants: Joe Prewett, Tillamook, OR (US); Amy Shoemaker, Tillamook, OR (US); Gillian Kennedy, Tillamook, OR (US); Steve Dennis, Tillamook, OR (US); Rebecca Anderson, Tillamook, OR (US); Eric Loper, Tillamook, OR (US); Amber Nyssen, Tillamook, OR (US); Justin Laabs, Tillamook, OR (US); Steve Marko, Tillamook, OR (US); Fermin Resureccion, Tillamook, OR (US)

(72) Inventors: Joe Prewett, Tillamook, OR (US); Amy Shoemaker, Tillamook, OR (US); Gillian Kennedy, Tillamook, OR (US); Steve Dennis, Tillamook, OR (US); Rebecca Anderson, Tillamook, OR (US); Eric Loper, Tillamook, OR (US); Amber Nyssen, Tillamook, OR (US); Justin Laabs, Tillamook, OR (US); Steve Marko, Tillamook, OR (US); Fermin Resureccion, Tillamook, OR (US)

(73) Assignee: Tillamook County Creamery Association, Tillamook, OR (US)

(21) Appl. No.: 16/678,964

(22) Filed: Nov. 8, 2019

Related U.S. Application Data
(60) Provisional application No. 62/758,182, filed on Nov. 9, 2018.

(51) Int. Cl. A23C 9/152; A23L 2/40; A23L 2/54; A23C 9/156; A23L 2/68; A23L 2/60; A23L 2/56

(52) U.S. Cl. CPC A23C 9/1524; A23L 2/40; A23L 2/54; A23L 2/56; A23L 2/68; A23L 2/60; A23C 9/1565

(57) ABSTRACT

Methods and apparatuses for creating and dispensing a dairy-based sparkling beverage are disclosed. Embodiments include creating a beverage mix comprised at least in part of milk and cream, sugar, and a flavor base. The beverage mix is carbonated, and placed into a pressurized container. In some embodiments, the beverage mix is nitrogenated and delivered from a tap. In other embodiments, the beverage mix is placed into individual consumer packages, which are pressurized with carbon dioxide. In still other embodiments, the individual consumer packages may further be pressurized with nitrogen.

### CROSS-REFERENCE TO RELATED APPLICATION

This application claims priority to U.S. Provisional Application No. 62/758,182, filed 9 Nov. 2018, which is hereby incorporated by reference herein in its entirety.

### TECHNICAL FIELD

Embodiments herein relate to the field of dairy-based beverages, and, more specifically, to sparkling dairy-based beverages with nitrogen infusion.

### BACKGROUND

Ice cream floats (“floats”) have been popular beverages for decades. As suggested by the name, an ice cream float is traditionally made by placing a scoop of ice cream into a carbonated soda, such as root beer, cream soda, or another flavored soda depending upon the consumer's taste. Owing at least partially to this two-part composition, ice cream float-style beverages are typically made just prior to consumption. The ice cream slowly melts into the soda during consumption, with the carbonation causing a creamy head to form. The soda itself usually is supplied either in pre-carbonated form from a can or a bottle, as in the case of a home-made float, or is carbonated on-site through a soda fountain, as in the case of a commercial establishment. The ice cream is likewise pre-made, and manually scooped into pre-dispensed soda. The amount of ice cream placed in the soda can vary depending upon the consumer's taste, with greater amounts of ice cream resulting in a thicker, creamery beverage. The ice cream is not typically mixed into the soda; rather, it is left to the consumer to stir in the ice cream to taste.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 depicts the operations of an example method for production and on-tap dispensing of a drinkable dairy product with multiple gas effect, according to various embodiments.

FIG. 2 depicts the operations of an example method for production and packaging of a consumer-packaged drinkable dairy product with multiple gas effect, according to various embodiments.

FIG. 3 depicts the operations of an example method for preparing the mix for a drinkable dairy product, such as may be used with the methods of FIGS. 1 and 2, according to various embodiments.

FIG. 4 depicts the operations of an example method for tap dispensing of a drinkable dairy product with multiple gas effect, such as may be used with the method of FIG. 1, according to various embodiments.

FIG. 5 is a block diagram of an example tap dispensing system to produce a drink with multiple gas effect, which may be used with the method of FIG. 4, according to various embodiments.

### DETAILED DESCRIPTION OF DISCLOSED EMBODIMENTS

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As discussed above, because of the two-part nature of a float and associated manual preparation, floats are generally prepared just prior to providing to the consumer. The manual preparation increases the serving time, as opposed to a soda by itself, which can be readily dispensed from a soda fountain, and often by the consumer. Moreover, because the two parts typically comprise an effervescent liquid part (carbonated soda) and a solid or semi-solid part (ice cream), a typical float is unsuitable for prepackaging. Various issues have prevented prepackaging, such as undesirable separation of cream and liquid components and an inability to maintain a desirable carbonation level, resulting in a sub-optimal mouthfeel.

Disclosed in various embodiments are ready-to-drink ice cream float-style beverages that may be stored in a refrigerated environment and sold in a pre-packaged, ready-to drink form. Such beverages include a dairy-based component that is rendered “sparkling” or effervescent by virtue of carbonation. Carbonation, by introduction of carbon dioxide gas or liquid carbon dioxide, as well as the effervescence of carbon dioxide gas coming out of solution, provides a “bite” or “tang” evocative of the soda base of a hand-made float. Consequently, these beverages provide a way to enjoy the classic experience of an ice cream float in a ready-to drink package. Beverages made according to disclosed embodiments have both a light sparkling texture and a velvety smooth finish, plus the creamy mouthfeel and taste of ice cream. Further, these beverages may be sold in single-serving or multi-serving packaging, such as a metal, plastic, or glass bottle, keg, growler, or other pressure holding vessel.

In other embodiments, a method of making and dispensing a dairy-based ice cream float-style beverage that is both carbonated and nitrogenated is also provided. Nitrogenation, particularly when delivered from a nitro-based tap and faucet system, acts in tandem with carbonation to provide an optimal mouthfeel, enhancing product smoothness and creaminess. In some embodiments, the beverage is made from one or more pre-mixed components and dispensed for consumption on-site, such as via a tap or properly equipped soda fountain. As will be discussed below, the method of making and dispensing the beverage includes mixing the ingredients, carbonating the mixture, and dispensing the carbonated mixture from a pressurized vessel via a nitro-based tap system. In some embodiments, the mixture is pressurized using a combination of carbon dioxide gas and nitrogen gas, or just nitrogen gas, to help achieve a desired mouthfeel.

Various disclosed embodiments result in a dairy-based float-style beverage with a characteristic appearance, aroma, flavor, aftertaste, and/or texture. The appearance of the beverage is thick, coating, with small bubbles throughout and an absence of settled solids (such as cocoa, depending upon the selected flavor) or broken emulsion. The aroma is indicative of the selected flavor, with an absence of spoiled dairy product or overly cooked egg. The flavor, in addition to the selected flavor, includes notes of fresh dairy, properly cooked egg, sweet sugar, and custard. The aftertaste likewise includes notes of fresh dairy and indicative of the selected flavor, with an absence of old or stale diary and old cooked egg notes; some lingering carbonation is present, evocative of a soda base in a hand-made drink. The texture should be thick, mouth coating, and creamy, similar to ice cream, with effervescence on the tongue and slightly sharp carbonation.

While both carbonation and nitrogenation result in effervescence, the resultant bubbles from nitrogenation are typically smaller than those produced via carbonation. Smaller bubbles can allow a more creamy texture compared to typical bubble size from carbonation. The presence of the carbonation with the nitrogenation results in a portion of the effervescence having a reduced bubble size compared to a float that is only carbonated, and a portion of the effervescence having bubbles larger from carbon dioxide. Thus, the inclusion of both nitrogenation along side carbonation in various embodiments can achieve a texture and mouthfeel that many consumers would find unique and preferable when compared to a float that is only carbonated, while still retaining the sparkling texture of carbonation.

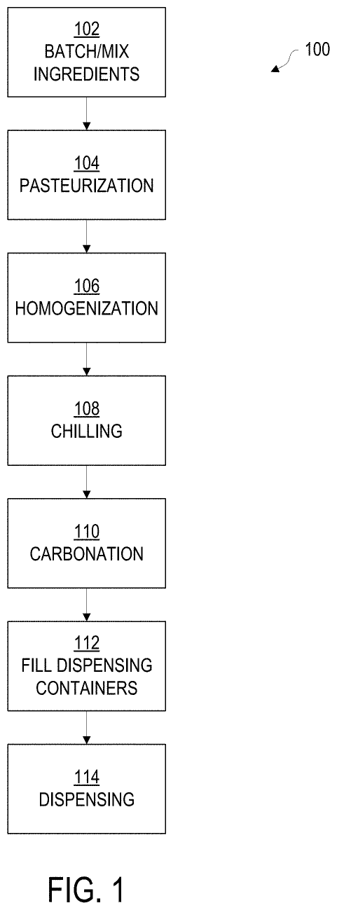

FIG. 1 depicts the operations of an example method 100 for preparing a dairy-based ice cream float-style beverage (“beverage”) for use with an on-tap system, according to various embodiments. The following operations may be performed in whole or in part, and in the listed order or in another order, depending upon the needs of a given implementation. Some implementations may omit certain operations or add additional operations.

Beginning in operation 102, the ingredients necessary for creating the beverage are collected, prepared, and mixed according to the particular recipe for a given drink. The ingredients, as will be seen, may include liquid and/or solid or dry ingredients, with some ingredients necessitating cold storage. One possible ingredient list is provided below, in Table 1, with possible weight ranges of each ingredient:

TABLE 1

| Ingredient | % by weight |
|---|---|
| 40% Cream | 20−30 |
| Whole Milk | 15−25 |
| Sugared Egg Yolk | <5 |
| Liquid Sucrose | 5−15 |
| (approx. 70% solids) | |
| Flavor Base | 5−15 |
| Stabilizer | <2 |
| Water | 25−30 |
| Total | 100.0% |

As will be understood, the percent weights of the combined selected ingredients will total 100%, e.g. selecting a weight on a lower end of one range will necessitate a greater weight from one or more of the other ranges. As seen in Table 1, the ingredients are measured out with respect to weight. The batch size can be scaled up or down by adjusting relative weights with respect to the listed percentage of each ingredient. It should be understood that the foregoing ingredients and amounts are just one possible example. In some recipes, the percent weight of one or more ingredients may deviate from the range(s) listed above. Different types of beverages may use varying ingredients and ingredient proportions. Further, as Table 1 is one example list, in some embodiments, additional ingredients not listed may be included depending upon the requirements of a given implementation. For example, other embodiments may include other ingredients such as buffer salts (to control any developed carbonic acid from hydrolyzing fat, denaturing protein, etc.), defoaming agents (to keep from having excessive gas related foaming when leaving the faucet), emulsifiers (to keep from breaking sensitive emulsions), and/or other suitable ingredients.

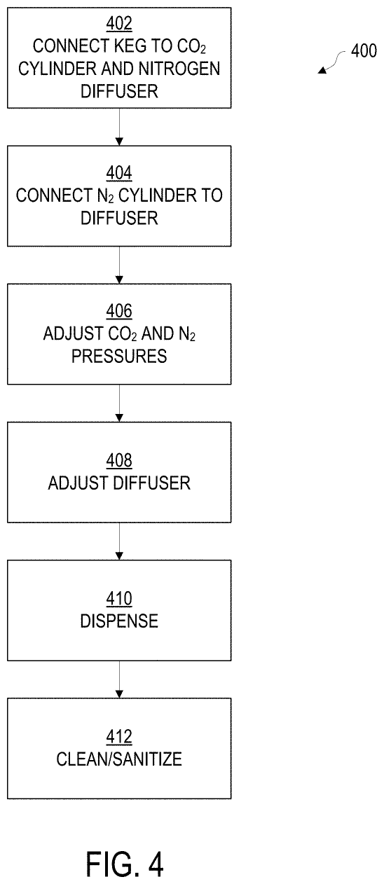

The specific operations for preparing and mixing the ingredients will be discussed in greater detail below in connection with FIG. 4.

In operation 104, the prepared mixture is pasteurized, to help arrest any microbial growth and extend the storage life of the mixture. In one possible embodiment, the batch is pasteurized to a temperature of 180 degrees F. Different pasteurization methods and/or different recipes may require a different pasteurization temperature and/or process. For example, a non-limiting list of some possible pasteurization techniques can include vat pasteurization, high temperature-short time (HTST), or ultra-high temperature (UHT) processing, as well as other possible non-thermal techniques, such as high pressure processing (HPP).

In operation 106, the prepared mixture is homogenized, to ensure a smooth texture and to help prevent separation. As will be understood, homogenization helps to break up fat globules and ensure a uniform size and distribution. In one possible embodiment, homogenization is performed between 500-3000 PSI. As with pasteurization, homogenization may be performed at different pressures and/or with varying methods depending upon the specifics of a given recipe.

In operation 108, the pasteurized and homogenized mixture is chilled to a temperature less than 40 degrees F. In one possible embodiment, chilling may be accomplished by passing the mixture through chilled plate structure, to allow the mixture to be rapidly chilled. Other methods of chilling the mixture, e.g. placing into a refrigerator for a predetermined amount of time, may be utilized depending upon the requirements of a specific embodiment or implementation. The method of chilling may be selected with respect to product throughput and/or cost.

Once chilled, in operation 110 the mixture is carbonated. In generally, carbonation involves exposing the mixture to pressurized carbon dioxide gas at a relatively low temperature, to cause the carbon dioxide to go into solution into the mixture. In one embodiment, the mixture is circulated through a carbonation device that exposes the mixture to carbon dioxide at approximately 30 PSI+/−10 PSI. The mixture may be passed through the carbonation device continuously, for a predetermined amount of time, to ensure approximately two (2) volumes, +/−1.5 volumes, of dissolved carbon dioxide. As will be understood by a person skilled in the art, a volume of carbon dioxide is the volume of carbon dioxide equivalent to the volume of the mixture being carbonated, at atmospheric pressure, e.g. two volumes of dissolved carbon dioxide into five liters of mixture would be ten liters of carbon dioxide at atmospheric pressure. In one particular embodiment, the predetermined amount of time was approximately one hour; this time may vary as necessary to achieve a desired level of dissolved carbon dioxide. The necessary pressure and time to achieve a given carbonation level will depend upon the temperature of the mixture, as will be understood. The mixture is typically carbonated at a temperature of 35 degrees F., +/−3 degrees, approximately 24 hours prior to service. Different recipes may require shorter or longer times and/or different temperatures and/or pressures to achieve optimal carbonation.

Alternatively, the mixture may be carbonated by placing the mixture into a keg or other pressure vessel that is pressurized with carbon dioxide to around 30 PSI, +/−10 PSI at 35 degrees F., +/−3 degrees, and allowing the mix to sit under pressure for between 4-5 days. The mixture may be top-pressurized, where the headspace between the top of the vessel is brought and maintained to pressure as indicated above. In some embodiments, the vessel may be equipped with a carbonation stone or a sparging stone to aid in proper carbonation, as well as potentially speed up the diffusion of carbon dioxide into the mixture as compared with simply top-pressurizing the keg or vessel. As will be understood, the carbonation stone or sparging stone is attached to the carbon dioxide source to provide direct diffusion of the carbon dioxide into the mixture. The carbonation stone or sparging stone may be positioned or affixed proximate to the bottom of the vessel to allow the gas to pass through the bulk of the mixture, helping to circulate the mixture and promote even carbonation. Other methods of carbonation may be employed; any suitable method of carbonation now known or later developed that results in the mixture achieving the desired carbonation level may be employed.

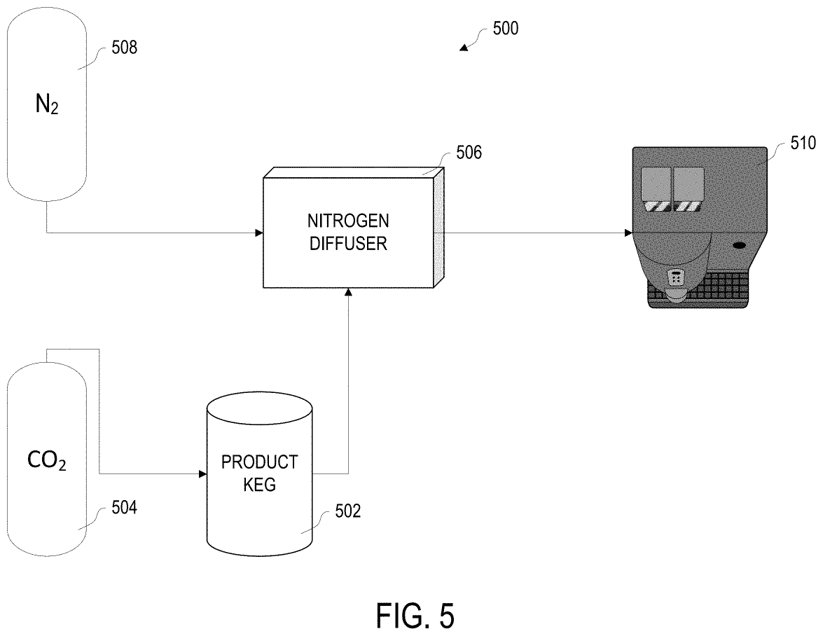

Following carbonation, the mixture may be transferred to a dispensing container, such as a keg or barrel, in operation 112 if not already filled into a container suitable for dispensing. As will be understood, any such containers should be sanitized and otherwise prepared for food contact. Once placed into the dispensing container, the empty space in the container, e.g. headspace, is charged to 30 PSI, +/−10 PSI of carbon dioxide. This charge helps maintain the carbonation of the beverage at the correct level, as previously established via carbonation in operation 110. Finally, in operation 114, the mixture is dispensed, such as via a nitro-based tap or faucet system fitted with an inline sparger or gas infusion module. The dispensing system, as will be discussed below with respect to FIGS. 4 and 5, can impact the presentation and mouthfeel of the final beverage.

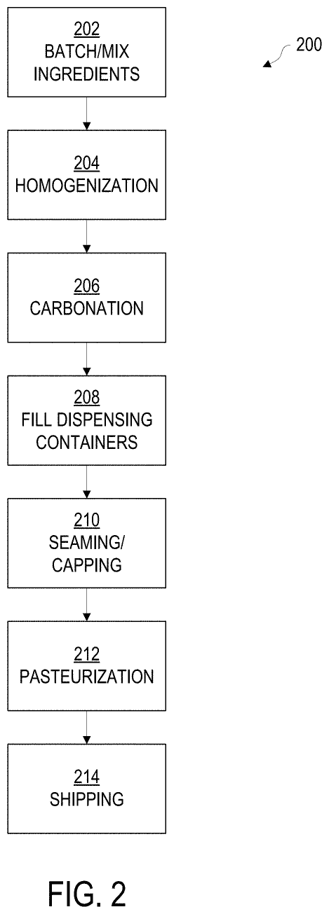

FIG. 2 depicts the operations of an example method 200 for preparing a dairy-based ice cream float-style beverage (“beverage”) for placement into a consumer package such as a can or a bottle or other pressure safe vessel, according to various embodiments. The following operations may be performed in whole or in part, and in the listed order or in another order, depending upon the needs of a given implementation. Some implementations may omit certain operations or add additional operations.

In operation 202, the ingredients are prepared and mixed per the recipe for a given beverage. As with operation 102 of method 100, the actual preparation steps will vary depending upon the particular beverage recipe, with an example embodiment being described below with respect to FIG. 4.

In operation 204, the mixture is homogenized. In one possible embodiment, the mixture is homogenized between 500-3000 PSI, similar to operation 106 of method 100.

In operation 206, the mixture is carbonated, similar to operation 110 of method 100. In one possible embodiment, the mixture is carbonated at a temperature of 35 degrees F., +/−3 degrees, and circulated through a carbonation device continuously for a predetermined amount of time to ensure approximately 2 volumes, +/−1.5 volumes of dissolved carbon dioxide. In some embodiments, the carbonation process may be controlled to achieve a target pH range to help ensure product stability prior to purchase and consumption.

In operation 208, the consumer packages are filled with the carbonated mixture. In one possible embodiment, a counterpressure filler may be employed, starting with 2.2 volumes of carbon dioxide at the start of a fill batch, and reducing to 2.0 volumes of carbon dioxide. Thus, the mixture is deposited into each consumer container under pressure, to maintain carbonation.

The consumer package may be a bottle, such as a glass or properly treated aluminum bottle, a can, or another suitable container. The choice of container may be made with respect to various processing steps, such as the choice of pasteurization process, described below. For example, if a heat-based pasteurization process is used, the container should be able to withstand the heat involved without degradation or releasing of chemicals into the contained food. In some examples, a flexible plastic container may be used, such as where a non-heat based process is used, e.g. HPP, to render the product microbially safe. As it will be receiving a carbonated beverage that may emit pressurized carbon dioxide, the container should be air-tight and strong enough to contain the evolved carbon dioxide without rupture or leakage, and also maintain the carbonation level of the mixture.

In some embodiments, the container may include a device such as a ball or widget to control release of nitrogen gas to produce a gas cascade, creamy head, and/or texture in the beverage upon opening of the container. The device, in embodiments, may contain nitrogen, which may be dosed via liquid nitrogen injection or another suitable technique just prior to container sealing. In conjunction with the carbon dioxide either pressurized into each package and/or evolved from the carbonated mixture, the dosed nitrogen will maintain the mixture under pressure, forcing some of the mixture into the device and keeping the nitrogen gas in the device pressurized. Further, the injection of nitrogen gas can cause the mixture to become partially nitrogenated, in addition to carbonated. Upon opening, the pressure on the mixture is reduced to atmospheric pressure, causing the gas in the device to force out any entrapped mixture, and encouraging evolution of effervescence from both carbon dioxide and nitrogen.

In other embodiments, the container may be charged with nitrogen instead of carbon dioxide, or may be charged by a mixture of nitrogen and carbon dioxide. The addition of nitrogen, possibly with an in-container device, may allow a creamy mouthfeel that approximates dispensing the beverage via a nitro-based tap system.

Following carbonation/nitrogentation, in operation 210 the filled and pressurized containers are seamed, capped, or otherwise sealed. The particular operations required under operation 210 will depend upon the type of consumer container being utilized. For example, a can may require seaming to fit a lid, while a bottle may require capping. A seaming operation may also be required on a capped container depending upon the type of cap employed.

In operation 212, the filled and sealed containers are pasteurized. Pasteurization may occur on a production line via a tunnel pasteurizer. In embodiments, the containers may be pasteurized at a temperature of 145 degrees F. or greater, following required time and temperature limits for a validated thermal kill step. These various temperatures and times may be employed depending upon the beverage recipe, container type and size, and/or pasteurizing equipment utilized. Other types of pasteurization or methods to ensure a microbially safe product may be employed, as described above with respect to operation 104 of method 100. As mentioned above, the choice of container may determine the process employed, or alternatively, the choice of process may necessitate the use of certain types of containers. For example, use of a HPP process (40,000-120,000 PSI) may require the use of a tough but flexible plastic container, as a typical aluminum bottle or can may not be able to withstand an HPP process without splitting or cracking.

Finally, in operation 214, the finished containers are chilled down below 40 degrees F., and prepared for transport and shipping. The containers may be provided to various retail outlets for purchase and consumption by consumers as desired.

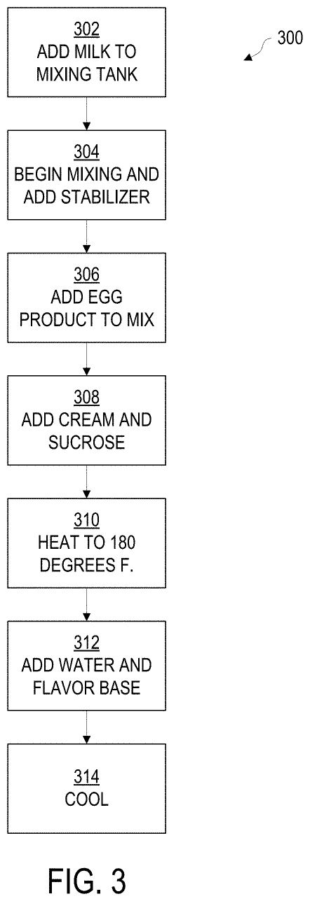

Turning to FIG. 3, the operations for an example method 300 for preparing the various ingredients of an example recipe, such as the ingredients listed above in Table 1, are depicted. The following operations may be performed in whole or in part, and in the listed order or in another order, depending upon the needs of a given implementation. Some implementations may omit certain operations or add additional operations. Method 300 may be performed in conjunction with either or both of methods 100 and 200, to provide the beverage for processing.

In operation 302, milk is weighed out and added to a suitable mixing tank. The tank may be configured to work with a high shear mixer for preparing the beverage. Other embodiments may use a different type of mixer. The mixing tank, as will be understood, should be sanitized and suitable for food contact. The size of the mixing tank will depend upon the size of the batch being prepared, which may be selected based upon the equipment to be used for subsequent processing operations.

In operation 304, the sheer mixer is activated, and a stabilizer is mixed into the milk. The stabilizer may be a mix of locust bean gum and gellan, or some other suitable stabilizing compound or mixture that helps prevent the beverage from separating while maintaining a desirable appearance, texture, mouthfeel, and other desired characteristics. The choice of stabilizer and amount utilized may depend upon the specifics of a given beverage recipe. In some implementations, such as where the beverage batch is to be consumed relatively quickly following production, e.g. where the batch is prepared on-premises and placed into a tap system, the stabilizer may be omitted.

In operation 306, the sugared egg product is added to the mix in the mixing tank, followed by cream and sugar in operation 306. The sugar may be in a liquid form, such as simple syrup. In embodiments, the sugar is sucrose; other recipes may employ different types of sugar, such as fructose or high-fructose corn syrup. The high shear mixer remains in operation to ensure all ingredients are fully and evenly blended.

In operation 310, the mix is heated to 180 degrees F., and held at that temperature for 15 seconds. Other recipes may require different temperatures and/or different cook times.

Following heating, in operation 312 water and the flavor base are added, and mixing is continued. The flavor base may be any desired flavor for the recipe, such as root beer, cream soda, orange soda, chocolate flavoring, etc. As will be understood, the specific ingredients and proportions may vary depending upon the selected flavor. For example, if the flavor base includes a sweetener, the amount of sucrose to be added may be reduced to ensure the resulting mix is kept at a desired degrees Brix of sweetness.

Finally, in operation 314, the mix is cooled. Once complete, the mix may be transferred into a container such as a keg or vat for processing with method 100 or 200, as described above. The mix may be cooled prior to transfer to the container, or may be cooled following transfer, e.g. by placing the keg or vat into a refrigeration unit. In other embodiments, operation 314 may be performed without placing the mix into a keg or vat, such as via chilling plates, and the mix sent directly to a filling apparatus, such as where method 200 is employed and the beverage is placed into consumer containers.

FIG. 4 describes an example method 400 for delivering the beverage via a nitro-based tap system, such as may be found at a commercial establishment. The tap system may operate similar to a soda fountain. The following operations may be performed in whole or in part, and in the listed order or in another order, depending upon the needs of a given implementation. Some implementations may omit certain operations or add additional operations. Method 400 may be performed from the beverage that results from method 100, for example. Further, method 400 may be employed with an example nitro-based delivery system, such as example system 500, described below with respect to FIG. 5.

In operation 402, a keg or other suitable container containing the beverage mix may be retrieved from refrigerated storage, in a pre-chilled and pre-carbonated configuration. The keg is then attached to a pressurized carbon dioxide cylinder via an input port on the keg. A keg output port is attached to a nitrogen diffuser (or nitrogenator, infuser, or sparger, as may be known to a person skilled in the relevant art), so that carbonated beverage is maintained under pressure by CO₂. This provides both pressure to cause the beverage to flow to the nitrogen diffuser, and also maintains the carbonation originally supplied when the mix and keg were prepared, such as via method 100. In some embodiments, the input and output ports may be supplied via a keg tap valve which inserts into the top of the keg, and acts as a valve to introduce the carbon dioxide and release the pressurized beverage.

In operation 404, a nitrogen gas cylinder is also hooked up to the nitrogen diffuser. Following connection of the nitrogen cylinder and keg to the diffuser, in operation 406, the pressures delivered by the carbon dioxide and nitrogen tanks can be set to the appropriate pressure levels. Pressure adjustment may be accomplished via a gas regulator, as is known in the art. In one embodiment, the nitrogen gas is set to 20 PSI, and the CO₂ gas is set to 35 PSI. In other embodiments, different pressure regulator settings may be employed for either or both of the carbon dioxide and nitrogen gasses. The choice of pressures may depend upon the selected carbonation level of the beverage in-keg, the specifics of a given beverage recipe, and/or the desired result from the tap, such as intended mouthfeel. In still other embodiments, the choice of pressures of either the carbon dioxide or the nitrogen may be determined by the specifications of the diffuser.

As a general principle for various embodiments, the selected gas pressure at a given operation or stage should be 1-3 PSI greater than the pressure from the preceding operation or stage. For example, if the keg is supplied pressurized at 30 PSI, the regulator supplying gas to the keg for headspace within the keg may be set to provide gases between 31-33 PSI. A subsequent stage providing nitrogen, e.g. by an inline sparger or nitrogenator, may be set or regulated to 32-36 PSI.

In operation 408, the diffuser or nitrogenator may be adjusted to deliver a desired level of nitrogenation. In some embodiments, the nitrogenator may be implemented at least in part with a valve. In other embodiments, the diffuser may not be adjustable, or adjustment may be accomplished via the pressure setting of the nitrogen and/or carbon dioxide gasses in operation 406 via regulator.

In operation 410, the beverage may be dispensed. Dispensing may include placing a glass under the tap or faucet at a 45° angle, and pulling the tap handle forward. The glass may be lowered as it fills, closing the tap when the pour is complete. If starting up after sanitation, the lines may first need to be filled following attaching the keg by placing a clean bucket under the tap and pulling the tap lever forward to clear any remaining sanitizer from the product lines, then closing the tap when the beverage begins to dispense.

Once the keg or container is empty (or if the system will not be used for an extended period of time), in operation 412 the dispensing system should be cleaned and sanitized. The method for cleaning and sanitizing the system may depend upon the type of system employed, the system's manufacturer specifications, and/or any relevant food safety regulations and best practices.

Referring to FIG. 5, an example system 500 for dispensing a beverage, such as a beverage prepared according to method 100, is depicted. System 500 may be used with, for example, method 400 for dispensing a carbonated beverage with a nitro-based system.

System 500 includes a product keg 502, that contains the beverage to be dispensed. A carbon dioxide gas tank 504 is connected to an input port for the product keg 502, which is in turn attached to an input port on a nitrogen diffuser 506. A nitrogen gas tank 508 is similarly attached to a second input port on the nitrogen diffuser 506. An output line runs from the nitrogen diffuser 506 to a beverage tap or fountain 510.

Product keg 502 may be filled with a carbonated beverage and placed under pressure, such as the result of operations 110 and 112 of method 100. The carbon dioxide gas tank 504 similarly may contain CO₂ gas under a greater pressure than the gas charge of the product keg 502, so that the pressure can be regulated to an appropriate level to maintain a consistent charge within the product keg 502. Product keg 502, as described above, may be a beverage keg, similar to a beer or wine keg. Product keg 502 may include built-in discreet input and output ports, and/or may include a fitting to accept a tap or faucet, which may supply the necessary input and output ports.

Gas tanks 504 and 508 may be compressed gas cylinders, such as may be commercially available. The carbon dioxide and nitrogen gasses should be sufficiently pure for food purposes, e.g. exposure to and diffusion into the beverage mix, without contaminants, particularly contaminants that may be absorbed or carried by the beverage mix, or may spoil or otherwise alter the taste, mouthfeel, or other pertinent attributes of the beverage when dispensed. Alternatively, other gasses may be used depending upon the particular recipe and beverage being dispensed.

Nitrogen diffuser (nitrogenator) 506 causes the nitrogen from gas tank 508 to be forced into solution into the beverage as it is dispensed. In some embodiments, diffuser 506 is a standalone unit, placed prior to the tap 510. In other embodiments, diffuser 506 may be integrated into the tap 510 unit. The amount of nitrogen diffused into the beverage may depend at least in part upon the pressure delivered to the diffuser 506 from the nitrogen gas tank 508 and/or by settings on the diffuser 506, if the diffuser 506 is so configured. The nitrogen may interact with the dissolved carbon dioxide in the carbonated beverage, affecting how it effervesces, and further affecting the mouthfeel and texture of the dispensed beverage. Thus, the settings of the diffuser 506 and/or regulated pressure of the nitrogen may allow the creaminess, mouthfeel, bite or tanginess, and other desirable attributes of the dispensed beverage to be fine tuned.

Tap or fountain 510 is essentially an adjustable valve, sized to allow for proper dispensing of the beverage. The valve may allow for controlling the rate of dispensing, to ensure the amount of head produced from the effervescence can be controlled.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for preparing a dairy-based beverage, comprising:
preparing a beverage mix;
carbonating the beverage mix with carbon dioxide gas;
filling a container with the beverage mix;
pressurizing the container with carbon dioxide gas to a predetermined pressure; and
nitrogenating the beverage mix with nitrogen gas.

2. The method of claim 1, further comprising dispensing the beverage mix from a tap or faucet.

3. The method of claim 2, wherein nitrogenating the beverage mix is performed with a nitrogen diffuser, infuser, or sparger.

4. The method of claim 2, wherein nitrogenating the beverage mix is performed in-line with the tap or faucet.

5. The method of claim 1, wherein:
filling the container with the beverage mix comprises filling a plurality of containers with the beverage mix,
pressurizing the container with carbon dioxide gas comprises pressurizing each of the plurality of containers to the predetermined pressure, and
nitrogenating the beverage mix comprises nitrogenating the beverage mix in each of the plurality of containers.

6. The method of claim 5, wherein nitrogenating the beverage mix in each of the plurality of containers comprises inserting, in to each of the plurality of containers, a device configured to release nitrogen gas into the beverage mix.

7. The method of claim 1, wherein preparing the beverage mix comprises:
mixing a plurality of ingredients to form the beverage mix;
pasteurizing the beverage mix; and
homogenizing the beverage mix.

8. The method of claim 7, wherein mixing the plurality of ingredients comprises mixing together milk, egg product, cream, sucrose, water, and flavor base.

9. The method of claim 8, wherein mixing the plurality of ingredients further comprises mixing in one or more of a stabilizer, buffer salt, defoaming agent, and/or an emulsifier

10. The method of claim 1, wherein carbonating the beverage mix comprises carbonating the beverage mix to a pressure of 30 PSI, +/−10 PSI.

11. An apparatus for dispensing a dairy-based beverage, comprising:
a carbon dioxide gas tank;
a nitrogen diffuser;
a nitrogen gas tank coupled to the nitrogen diffuser;
a beverage mix container coupled to the carbon dioxide gas tank and the nitrogen diffuser so that the nitrogen diffuser receives a carbonated beverage mix stored within the beverage mix container; and
a tap or faucet coupled to the nitrogen diffuser so that the tap or faucet receives a nitrogenated and carbonated beverage mix from the nitrogen diffuser.

12. The apparatus of claim 11, wherein the beverage mix container further comprises the carbonated beverage mix.

13. The apparatus of claim 12, wherein the nitrogen diffuser can be adjusted to alter a balance between dissolved carbon dioxide and dissolved nitrogen in the beverage mix.
